(19) United States
(12) Patent Application Publication
(10) Pub. No.: US 2003/0106704 A1
(43) Pub. Date: Jun. 12, 2003

(54) Electrical cable apparatus

(76) Inventors: James A. Isley, Omaha, NE (US); Paul Koehler, Omaha, NE (US); Daniel J. Parke, Omaha, NE (US); David Allyn Wiebelhaus, Omaha, NE (US); Stephen Taylor Zerbs, Gretna, NE (US)

Correspondence Address: Daniel J. Santos, Esq., Thomas, Kayden, Horstemeyer & Risley, L.L.P., Suite 1750, 100 Galleria Parkway, Atlanta, GA, 30339, US

(21) Appl. No.: 10/008,438

(22) Filed: Dec. 6, 2001

(51) Int. Cl. H01B 11/02

(52) U.S. Cl. 174/113 R

(57) ABSTRACT

An electrical cable has twenty or more twisted pairs of conductors therein formed into units of three twisted pairs and four twisted pairs, with a centrally located additional four pair unit. Dielectric film or tape partially surrounds either the three pair units or the four pair units or both to maintain separation of each unit from adjacent units. The conductors of the pairs in each unit have different twist lengths relative to the other conductors in the unit, and the units have different lay lengths, depending on the number of pairs in each unit.

### RELATED PATENTS

This application deals with related subject matter to that of U.S. patent application Ser. No. 09/396,682 of P. E. Neveux, filed Sep. 4, 1999, the disclosure of which is incorporated by reference herein.

### FIELD OF THE INVENTION

The invention relates to electrical cabling. More particularly, the invention relates to reducing cross-talk in electrical cabling, particularly in LAN cables having a large number of twisted pairs, such as twenty or more.

### BACKGROUND OF THE INVENTION

Within electrical cable such as that used in a local area network (LAN), the reduction of crosstalk remains an ongoing problem for the communication industry. Conventionally, within an electrical cable that typically contains a plurality of twisted pair of individually insulated conductors such as copper wires, many configurations and techniques have been implemented to reduce crosstalk between the respective electrically conducting pairs.

For example, one of the most useful techniques for reducing crosstalk within electrical cabling includes separating longitudinally parallel and adjacent transmission lines. In this manner, numerous components such as spacer elements have been included in the electrical cable to maintain sufficient spacing between the conducting pairs and thus reduce cross-talk therebetween, see, for example, U.S. Pat. Nos. 4,920,234 and 5,149,915. Because typical communications industry electrical cables include four twisted pairs, many spacer element configurations comprise one or more centrally-located spacer elements, such as a dielectric flute, with the twisted pairs arranged in various configurations therearound, see, for example, U.S. Pat. Nos. 5,132,488 and 5,519,173.

However, these conventional cable arrangements aimed at reducing crosstalk often are burdened with other problems. For example, existing spacer elements are relatively inflexible and thus restrict movement of the twisted pairs within the electrical cable. Also, existing spacer elements are relatively expensive and difficult to handle and manipulate during the electrical cabling manufacturing process.

A widely used cable configuration is the twenty-five (25) pair LAN cable, which generally comprises four, four twisted pair units and three, three twisted pair units all encased in an outer jacket, with one four pair unit as a central member and the six remaining units arrayed around the center unit in alternation between the three and four pair units. Current 25 pair UL verified CAT5 cables have a limited cross-talk margin in the frequency range f=0.772-100 MHz, which gives limited margin to enhanced performance specifications. In addition, users desire a spatially efficient cable that meets CAT 5e and CAT crosstalk specifications. The remainder of the disclosure is directed to the case of a twenty-five pair cable. However, other cables of a different pair count are also amenable to improved performance utilizing the principles and features of the invention as disclosed hereinafter.

Efforts to improve the cross-talk performance of twenty-five pair cables have generally involved jacketing at least the four pair units, which entails an additional cost factor adding to the expense of manufacture. In small pair cables, as exemplified in the aforementioned related Neveux application, additional separation between pair units is achieved and maintained with the use of separator tape flat or semicircles between or around the two pair units. Some manufacturers jacket the three pair and the four pair cables, then surround the jacketed cables with another jacket. This introduces an additional cost factor into the cable fabricating process. Thus far, economically viable anti-cross-talk separation for twenty-five pair cables has not been adequately addressed.

Accordingly, it would be desirable to have electrical cabling that addresses the aforementioned concerns.

### SUMMARY OF THE INVENTION

The present invention is embodied in a LAN cable having a plurality of twisted pairs. In a preferred embodiment, the cable has twenty-five (25) twisted pairs in four units of four pairs and three units of three pairs, although it is to be understood that the invention can be used with other numbers of twisted pairs, in which the pair count is different, in which case a combination of pair units may only involve four pair units. In general, the number of three pair units depends upon the total number of pairs not being divisible by four. Thus, for example, a twenty-two pair cable would have four four pair units and two three pair units and a thirty pair unit could have six four pair units and two three pair units. Hereinafter, when the term “combination” is used, it is to be understood that that may include no three pair units. The cable of the invention is configured to have a center unit of four twisted pairs and the remaining three pair units and four pair units are arrayed in alternation in a circle thereabout. In accordance with the invention, in a preferred embodiment thereof, the three pair units are partially enclosed or surrounded by longitudinal tape members each of which forms a roughly semi-circular separator that partially surrounds the unit and maintains its separation from the four pair units adjacent thereto. By “partially surrounds” is meant that the unit is not completely enclosed by the longitudinal tape members. The tapes are preferably made of foamed polypropylene (PP) or fire retardant polypropylene (FRPP) of approximately ten mils thickness and 0.28 to 0.38 inches width, although other suitable materials may be used.

In a second embodiment of the invention, the tapes partially surround the four pair units to establish and maintain their separation from the three pair units.

In both cases, the flexibility of the cable is maintained with the dielectric spacer tapes in place, and substantial improvement in the minimum power sum cross-talk margin is realized. The dielectric separators can be made of materials other than PP or FRPP, with appropriate care in the selection thereof. In the case where a fire retardant cable is desired, the cable of the invention has shown, in burn performance in the UL 1666 Riser Flame Test, an improvement over a standard twenty-five pair cable. It should be obvious to those skilled in the art that this invention can apply to other cable constructions, e.g. the UL 910/NFPA 262 Plenum Burn Test.

In a third embodiment of the invention, each of the pair units, both three pair and four pair, is partially surrounded by a spacer tape where even greater cross-talk suppression is desired.

In a fourth embodiment of the invention, the pairs within a unit, either three pair or four pair, may also be separated by a spacer tape, in addition to the spacer tapes of either the first or second embodiment where high performance is desired regardless of manufacturing cost.

In all of the embodiments the principles of the invention make it unnecessary to jacket the small pair cables, thereby reducing production costs.

The various principles and features of the present invention will be readily evident from the following detailed description, read in conjunction with the accompanying drawings.

### BRIEF DESCRIPTION OF THE DRAWINGS

FIG. 1 is a cross-sectional view of a prior art four pair cable;

FIG. 2 is a cross-sectional view of a flour pair cable incorporating the related invention of Neveux;

FIG. 3 is a cross-sectional view of a twenty-five pair LAN cable embodying the principles of the present invention;

FIG. 4 is a cross-sectional view of the second embodiment of twenty-five pair cable of the present invention;

FIG. 5 is a cross-sectional view of another embodiment of the invention;

FIG. 6 is a cross-sectional view of still another embodiment of the invention.

### DETAILED DESCRIPTION

In the following description similar components for clarity and consistency are referred to by the same reference numeral throughout the several figures.

Electrical cabling such as that used in a local area network (LAN) continues to suffer adversely from the reactive effects of parallel and adjacent conductors, e.g., inductive and capacitive coupling, also known as “crosstalk”. Conventional electrical cabling includes a jacket containing a plurality of twisted pairs of individually insulated conductors such as copper wires. However, as the number of conductor pairs within an electrical cable increases, more potential exists for crosstalk interference. Furthermore, crosstalk becomes more severe at higher frequencies, at higher data rates, and over longer distances. Thus, crosstalk effectively limits the useful frequency range, bit rate, cable length, signal to noise (s/n) ratio and number of conductor pairs within a single electrical cable for signal transmission. Moreover, crosstalk often is more pronounced in bidirectional transmission cables. Such effect is known as “near end crosstalk” (NEXT), and is particularly noticeable at either end of the cable where signals returning from the opposite end are weak and easily masked by interference.

It is known that, in general, crosstalk is better controlled by separating parallel and adjacent transmission lines or by transposing the signals along the cable to minimize the proximity of any two signals. Accordingly, many electrical cable arrangements exist that include spacer elements to maintain sufficient spacing between the conducting pairs and thus reduce cross-talk therebetween. As mentioned previously herein, see, e.g., U.S. Pat. Nos. 4,920,234; 5,149,915; 5,132,488; and 5,519,173.

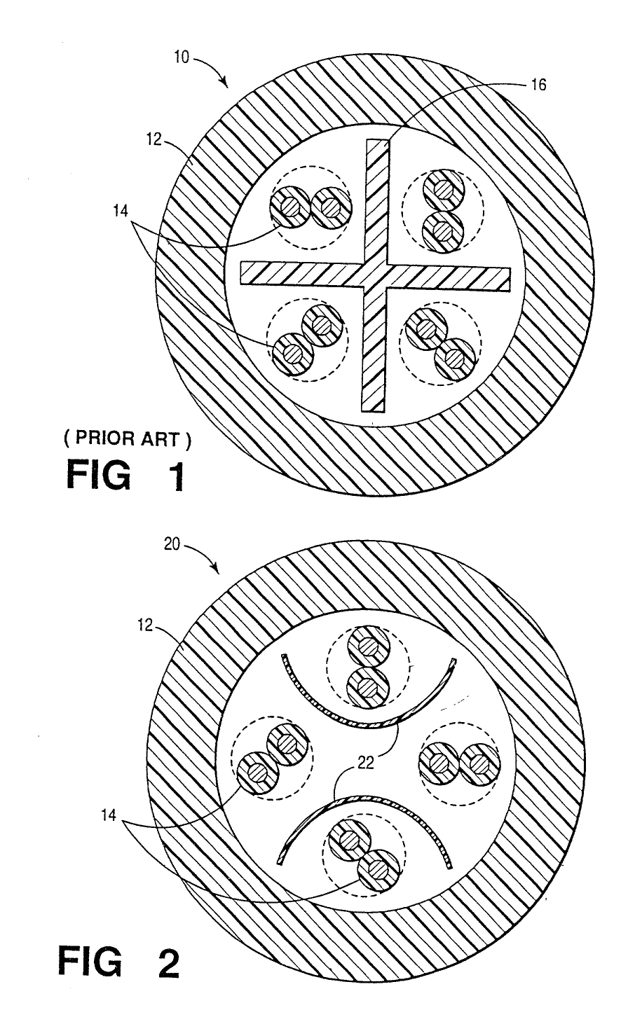

Referring now to FIG. 1, shown is a conventional prior art electrical cable 10 having an arrangement aimed at reducing crosstalk. The electrical cable 10 comprises a jacket 12, made of a suitable polymeric material, surrounding four pair of individually insulated conductors or conductive elements 14 separated by a spacer or spacer means 16. The individually insulated conductor pairs typically comprise twisted pairs of copper wire, and the spacer means 16 typically is made of a suitable dielectric material such as poly(vinyl chloride) (PVC).

In operation, the spacer means 16 maintains substantially constant spacing between the conductor pairs along the length of the electrical cable. In this manner, crosstalk is reduced therebetween. For example, when only two of four twisted pair are active, typically alternating conductor pairs are active to inherently reduce crosstalk. That is, for an electrical cable arrangement of four twisted pair of conductors and each twisted pair generally occupying a different quadrant within the electrical cable jacket, typically the first and third pairs are active and the second and fourth pairs are inactive. In this manner, a certain degree of spacing for reducing crosstalk is inherent in the specific arrangement of the electrical cable.

Although such conventional arrangements may reduce crosstalk to a certain degree, many of these conventional cable arrangements aimed at reducing crosstalk often are burdened with other problems, as discussed previously herein. For example, many spacer means 16 are relatively inflexible and thus restrict movement of the conductor pairs within the electrical cable. Also, the inflexibility of the spacer means 16 makes them difficult to handle and incorporate into the electrical cables during fabrication of the electrical cable. Furthermore, many spacer means 16 are relatively expensive and contribute significantly to the overall cost of the cable.

Referring now to FIG. 2, an electrical cable 20 according to embodiments of the aforementioned Neveux application is shown. The electrical cable 20 includes a jacket 12 formed around a plurality of pairs of individually insulated conductors or conductive elements 14, typically four pair as shown. The jacket 12 is made of any suitable flexible, electrically insulating material, e.g., a fluoropolymer, poly(vinyl chloride) (PVC), a polymer alloy or other suitable polymeric material. The conductors pairs, which typically are twisted pairs of copper wire, are individually insulated with, e.g., polyolefin, flame retardant polyolefin, fluoropolymer, PVC, a polymer alloy or other suitable polymeric material.

In accordance with the teaching of Neveux, spacing between the conductor pairs is maintained by a dielectric film 22 advantageously positioned around particular conductor pairs. The dielectric film 22 includes material such as, e.g., Kapton® film (polyamide) woven glass yam tape, ethylchlorotrifluoroethylene (ECTFE or Halar®), polyvinyl chloride (PVC), polyolefins and fluoropolymers including fluorinated ethylenepropylene (FEP or Teflon®), perfluoroalkoxy polymers of tetrafluoroethylene and either perfluoropropyl ether (PFA) or perfluoromethylvinyl ether (MFA) or other suitable electrically insulating material. The dielectric film has a width, e.g., of approximately 0.125 to approximately 0.250 inch and a thickness, e.g., of approximately 0.002 to approximately 0.020 inch (2 to 20 mils).

The thin dielectric film 22 is advantageous in that it reduces crosstalk. However, its flexible construction and material smoothness also allows it to slide relatively easily with respect to other components in the electrical cable jacket, including the conductors 14 and other dielectric films. The size and shape of the dielectric film 22 makes it relatively easy to manufacture and incorporate into existing electrical cable fabrication processes. In this manner, the thin dielectric film 22 compares favorably with, e.g., the bulky, inflexible flute used in conventional configurations.

According to the embodiment shown in FIG. 2, for an electrical cable 20 having four conductor pairs, two thin dielectric films are positioned around alternating conductor pairs (e.g., the first and third pairs) in such a manner that the spacing between adjacent conductor pairs is substantially constant along the length of the cable. In this manner, the conductor pairs are separated to the extent that the conductor pairs generally occupy separate quadrants within the electrical cable 20.

It should be noted that the particular arrangement shown in FIG. 2 is for illustration purposes only and is not meant to be a limitation of the invention. Thus, although in this particular embodiment four conductor pairs and two dielectric films are shown, such is not necessary according to embodiments of the invention. That is, it is within the scope of embodiments of the Neveux invention to have an electrical cable with as few as two conductor pairs and a single dielectric film. Regardless of the particular configuration, one or more dielectric films are used to separate conductor pairs to reduce crosstalk therebetween, in accordance with embodiments of the invention.

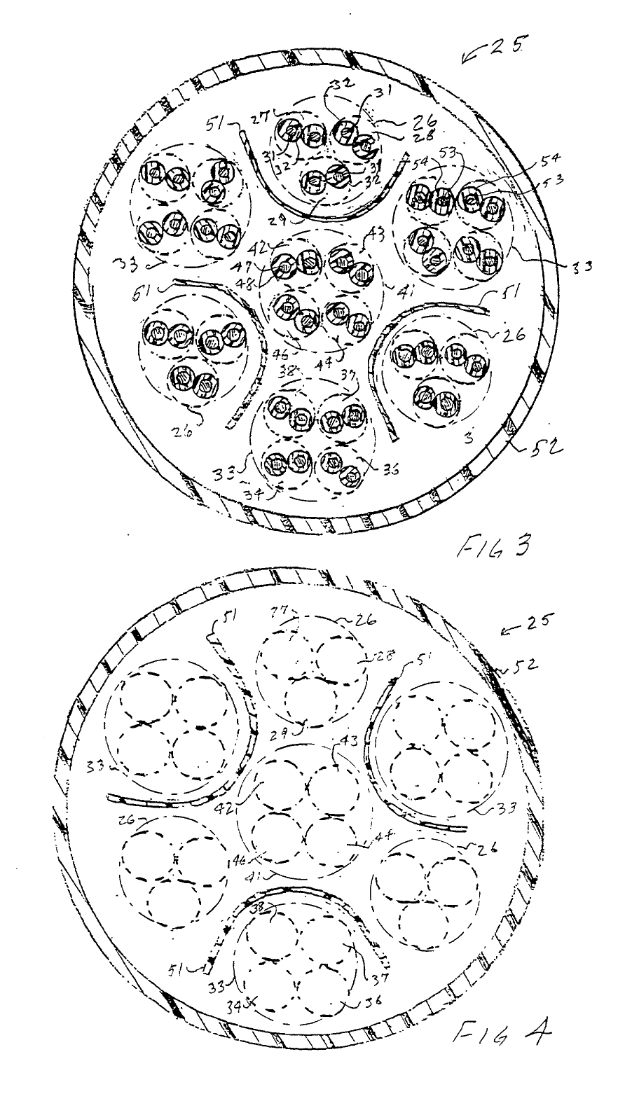

FIG. 3 depicts in cross-section a first embodiment of the present invention which comprises a twenty-five (25) pair cable which has three groups or units 26 of three twisted pairs 27, 28, and 29 of conductors, each comprising a central conductor 31 encased in suitable insulation material 32. As a crosstalk reduction measure, each twisted pair has a different twist length, thus pair 27 has, for example, a twist length of 0.420 inches; pair 28 a twist length of 0.500 inches; and pair 29 a twist length of 0.620 inches. The unit strand lay of the group 26 is, for example, 4.10 inches. Cable 25 further comprises three groups or units 33 of four twisted pairs 34, 36, 37, and 38 conductors each comprising a central conductor 53 encased in suitable insulation 54. As with the three pair units 26, each of the twisted pairs 34, 36, 37, and 38 has a different twist length. Thus, pair 34 has, for example, a twist length of 0.410 inches, pair 36 has a twist length of 0.460 inches; pair 37 a twist length of 0.583 inches; and pair 38 has a twist length of 0.700 inches. A fourth four twisted pair unit 41 is centrally located in the cable 25 along the length thereof comprises twisted pairs 42, 43, 44, and 46, each comprising a conductors 47 encased in suitable insulation 48. Pair 42 has a twist length of 0.400 inches; pair 43 of 0.440 inches; pair 44 of 0.556 inches; and pair 46 of 0.670 inches. The unit strand lay of unit 41 is, for example., 2.50 inches.

As a further crosstalk reducing measure, the spacing between the several units is maintained by a suitable dielectric film or tape 51 which partially surrounds each of the three units 26 and functions to maintain their separation from adjacent four pair units 33. Film or tape 51, which, in each case, extends the length of the three pair units 26, may include any of a number of dielectric, flexible materials such as, for example, foamed polypropylene tape, a polyimide woven glass yarn tape, such as Kapton®, polyvinyl chloride, or any of several polyolefins and/or fluoropolymers such as noted in the aforementioned Neveux application, or any of several other insulating materials, including fire retardant materials such as fire retardant polypropylene. The film or tape is preferably approximately ten mils in thickness and 0.28 to 0.38 inches wide.

The assemblage of three pair and four pair units which make up the conductive portion of the cable is surrounded by a jacket 52 of suitable polymeric material.

The film or tape 51, by maintaining the separation between adjacent multi-twisted pair reduces crosstalk in a structure, the fabrication of which is economically advantageous. Additionally, the flexibility and smoothness of the films 51 allow it to slide easily relative to the pair units when, for example, the cable is bent or twisted. It has been found that the electrical performance of the cable of the invention, as depicted in FIG. 3, compares favorably with cables of the type shown in FIG. 1, as well as others, with the added advantages of flexibility and economy of fabrication.

FIG. 4 is a partial cross-section view of the cable 25, but with the dielectric film or tape 51 partially surrounds each of the four pair units 33 instead of the three pair units 26. The details of the conductor 53 and insulation 54 have been omitted to avoid a plethora of reference numerals in a limited space. The embodiment of the invention depicted in FIG. 4 is, except for the location of the tapes 51, substantially identical to that shown in FIG. 3, with the twisted lengths and unit strand lays being approximately the same as those for the embodiment of FIG. 3, and the operative results are substantially the same. The invention shown in both embodiments advantageously gives not only economics of manufacture but also given as increased or improved reproductibility which, in itself, enhances the economy of manufacture.

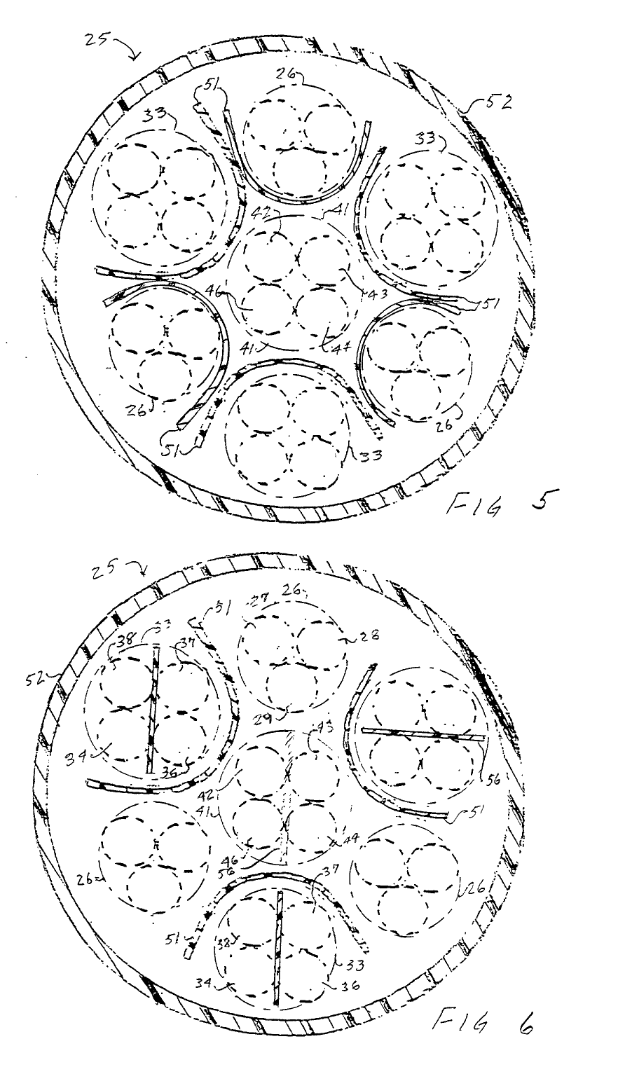

FIG. 5 depicts another embodiment of the invention wherein tapes 51 partially surround each of the three pair units 26 and the four pair units 33. With such an arrangement, spacing is maintained between all adjacent units, including the center core unit 41. The arrangement of FIG. 5 produces enhanced cross-talk performance and increased reproducibility at the expense of a small increase in fabrication costs.

In FIG. 6 there is shown an embodiment of the invention which includes tape members 56 separating twisted pairs 34 and 38 from pairs 36 and 37 in each of the four pair units 33, and separating pairs 42 and 46 from pairs 43 and 44 in unit 41. Such an arrangement further enhances crosstalk performance and reproductibility of acceptable performance at the expense of a small increase in fabrication costs.

It is to be understood that the various features of the present invention, while designed primarily for use in a multi-paired cable, such as a twenty-five pair LAN cable, might be incorporated into other multi-paired cables, and that other modifications or adaptations might occur to workers in the art. For example, the principles and features are applicable to four pair, eight pair, twelve pair, sixteen pair, and twenty pair cables as well as to cables of twenty-five or more pairs. All such variations and modifications are intended to be included herein as being within the scope of the present invention. Further, in the claims hereinafter, the corresponding structures, materials, acts and equivalents of all means plus function elements are intended to include any structure, material or acts for performing the function sin combination with other elements as specifically claimed.

1. An electrical cable comprising
a multiplicity of longitudinally extending twisted pairs of conductive elements, said pairs being grouped into at least one four pair unit;
at least one dielectric film member separating at least one unit from adjacent units for maintaining separation between adjacent units; and
a dielectric jacket surrounding and enclosing the multiplicity of twisted pairs.

2. An electrical cable as claimed in claim 1 wherein there are four four pair units.

3. An electrical cable as claimed in claim 1 wherein there are twenty-five twisted pairs divided into a combination of three three pair units and four four pair units.

4. An electrical cable as claimed in claim 3 wherein each of the dielectric film members partially surrounds a three twisted pair unit.

5. An electrical cable as claimed in claim 3 wherein each of the dielectric film members partially surrounds a four twisted pair unit.

6. An electrical cable as claimed in claim 1 wherein there are a plurality of units and wherein all of said units are partially surrounded.

7. An electrical cable as claimed in claim 1 wherein said at least one four pair units has at least one second dielectric film member separating two of the twisted pairs therein from the other two twisted pairs therein.

8. An electrical cable as claimed in claim 1 wherein said dielectric film members comprise one or more materials from the group consisting of polypropylene tape, polyimide woven glass, polyvinyl chloride, and one or more polyolefins, and one or more flouropolymers.

9. An electrical cable as claimed in claim 1 wherein said dielectric film members comprise foamed polypropylene tapes extending longitudinally along said conductors.

10. An electrical cable as claimed in claim 1 wherein said dielectric film members comprise fire retardant polypropylene.

11. An electrical cable comprising:
at least twenty-five longitudinally extending twisted pairs of insulated conductors, said conductors being formed into a group of six units of three three twisted pair units and three four twisted pair units, and one additional unit of four twisted pairs;
said additional unit being centrally located on said cable with said group of six units arranged in alternation thereabout;
a plurality of dielectric film members, each film member partially surrounding an individual unit and extending longitudinally therealong; and said units and said film members being surrounded and enclosed by a dielectric jacket.

12. An electrical cable as claimed in claim 11 wherein
each of said twisted pairs in a three pair unit of said group has a twist length different from that of the other pairs therein and the unit has a first strand lay.

13. An electrical cable as claimed in claim 11 wherein
each of said twisted pairs in a four pair unit of said group has a twist length different from that of the other pairs therein and the unit has a second strand lay differing from said first strand lay.

14. An electrical cable as claimed in claim 13 wherein
each of the twisted pairs in said additional unit has a twist length different from the other pairs in said additional unit and the unit has a third strand lay different from said first and second strand lays.

15. An electrical cable as claimed in claim 12 wherein
the several twisted lengths in said additional unit are different from any of the twist lengths of the pairs in the three four pair units of said group.

16. An electrical cable as claimed in claim 15 wherein
a dielectric film member partially surrounds each of the three pair units in said group of six units.

17. An electrical cable as claimed in claim 15 wherein
a dielectric film member partially surrounds each of the four pair units in said group of six units.

18. An electrical cable as claimed in claim 15 wherein
a dielectric film member partially surrounds each of the six units in said group of units.
